(19) United States
(12) Patent Application Publication
(10) Pub. No.: US 2014/0339731 A1
(43) Pub. Date: Nov. 20, 2014

(54) MOLDED ARTICLE MANUFACTURING APPARATUS, AND METHOD OF MANUFACTURING MOLDED ARTICLE

(71) Applicant: Toshiba Kikai Kabushiki Kaisha, Tokyo (JP)

(72) Inventor: Nobuyuki ASANUMA, Numazu-shi (JP)

(73) Assignee: Toshiba Kikai Kabushiki Kaisha, Tokyo (JP)

(21) Appl. No.: 14/277,533

(22) Filed: May 14, 2014

(30) Foreign Application Priority Data
May 15, 2013 (JP) 2013-103071
Mar. 18, 2014 (JP) 2014-055447

(51) Int. Cl. B29C 45/14

(52) U.S. Cl. CPC B29C 45/1418; B29C 2045/14983
USPC 264/266; 425/556; 425/589

(57) ABSTRACT

A molded article manufacturing apparatus is configured to include a mold clamping device configured to be able to support a die which shapes a sheet-shaped insert member, the die including a fixed die with a gate, and a movable die which is movable relative to the fixed die; an injection device configured to inject a molding material into the die; and boring means configured to form a bore portion, which is continuous with the gate, in the insert member which is inserted into the die that is supported by the mold clamping device.

### CROSS-REFERENCE TO RELATED APPLICATIONS

This application is based upon and claims the benefit of priority from Japanese Patent Application No. 2013-103071, filed May 15, 2013, and Japanese Patent Application No. 2014-055447, filed Mar. 18, 2014 the entire contents of all of which are incorporated herein by reference.

### BACKGROUND OF THE INVENTION

1. Field of the Invention

The present invention relates to a molded article manufacturing apparatus and a method of manufacturing a molded article for manufacturing a molded article by using a sheet-shaped insert member.

2. Description of the Related Art

Conventionally, there is known a technique in which a sheet-shaped insert member is inserted into a die and pressed, thereby shaping the insert member and manufacturing a molded article. There is also known a molded article manufacturing technique, in which an insert member is shaped, and further, a molded part, such as a boss or a rib, is formed by injection molding.

In addition, such an insert member is formed in a sheet shape, for example, by impregnating a prepreg, which is formed of a fabric material, with a thermoplastic resin material, and the insert member can be shaped by heating. As regards the heating of the insert member, there is known a molded article manufacturing apparatus which is configured such that an insert member is conveyed to a heating device and a die by a conveying device which conveys the insert member by placing the insert member on conveying means.

Further, as disclosed in Jpn. Pat. Appln. KOKAI Publication No. 2008-126526, there is known a technique in which injection molding is performed on a core material, which has a penetrating bore portion, such that the entirety of an outside of the core material, is covered with a skin material.

In the above-described molded article manufacturing methods, a prepreg (insert member), which is impregnated with a thermoplastic resin, needs to be bored in advance by a trimming device or the like, before the prepreg is inserted into a molding apparatus, and there is a concern that the manufacturing cycle of the molded article increases, or the manufacturing cost increases.

### BRIEF SUMMARY OF THE INVENTION

According to an embodiment of the present invention, a molded article manufacturing apparatus includes a mold clamping device configured to be able to support a die which shapes a sheet-shaped insert member, the die including a fixed die with a gate, and a movable die which is movable relative to the fixed die; an injection device configured to inject a molding material into the die; and boring means configured to form a bore portion, which is continuous with the gate, in the insert member which is inserted into the die that is supported by the mold clamping device.

According to an embodiment of the present invention, a method of manufacturing a molded article includes inserting a sheet-shaped insert member in a die including a fixed die with a gate, and a movable die which is movable relative to the fixed die; shaping, by the die, the insert member which is inserted; injecting, by an injection device, a molding material into the die; and boring the insert member by a pressure of the molding material which is injected by the injection device.

According to an embodiment of the present invention, a method of manufacturing a molded article includes inserting a sheet-shaped insert member into a die including a fixed die with a gate, and a movable die which is movable relative to the fixed die; shaping, by the die, the insert member which is inserted; boring the insert member by an extrusion pin configured to be able to push a molded article after molding; and injecting, by an injection device, a molding material into the die.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view which schematically illustrates the structure of a molded article manufacturing apparatus according to a first embodiment of the invention.

FIG. 2 is a cross-sectional view which schematically illustrates a main structure used in the molded article manufacturing apparatus, this structure relating to a fabrication process of a molded article.

### DETAILED DESCRIPTION

### First Embodiment

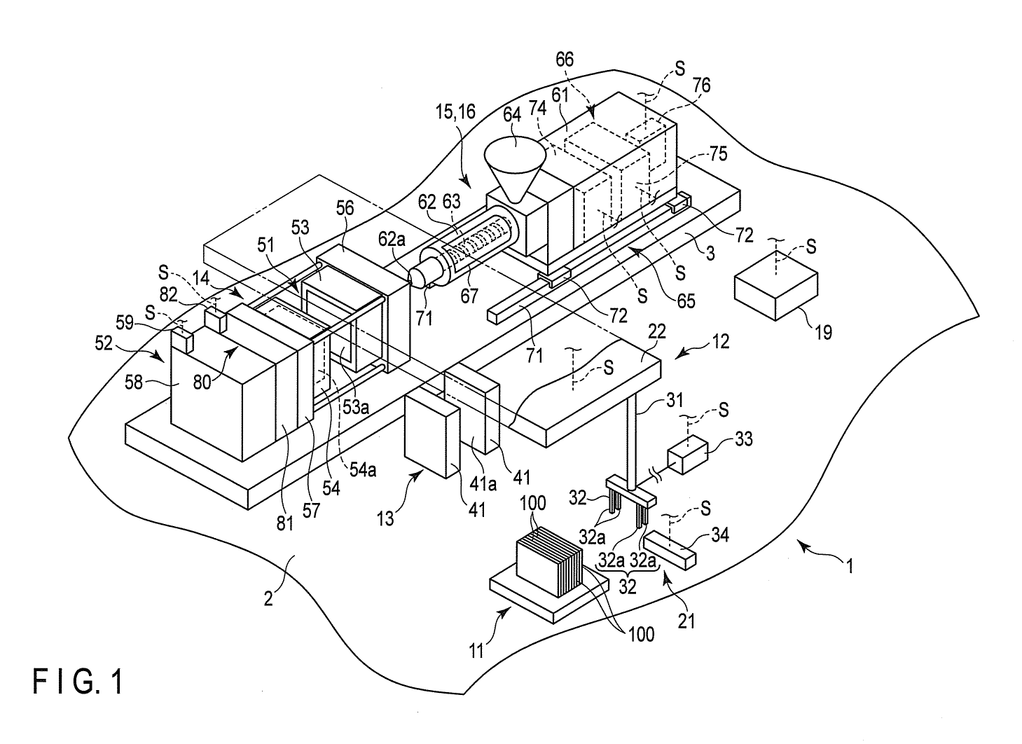

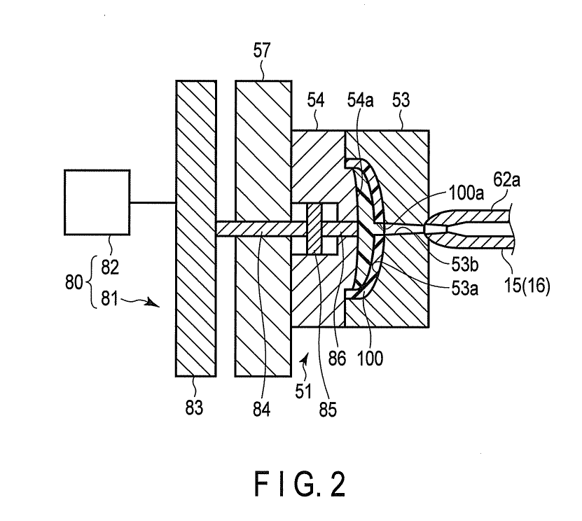

A molded article manufacturing apparatus according to a first embodiment of the present invention will be described hereinafter with reference to FIG. 1 and FIG. 2.

FIG. 1 is a perspective view which schematically illustrates the structure of a molded article manufacturing apparatus 1 according to a first embodiment of the invention. FIG. 2 is a cross-sectional view which schematically illustrates a main structure used in the molded article manufacturing apparatus 1, to be more specific, the structure of a die 51 and a prepreg 100, FIG. 2 illustrating an example of manufacture of a molded article.

As illustrated in FIG. 1, the molded article manufacturing apparatus 1 includes a storage section 11, a convey device 12, a heating device 13, a mold device 14, an injection device 15, boring means 16, and a control device 19. The molded article manufacturing apparatus 1 is disposed in an installation range 2 in a factory, etc., and the mold device 14 and injection device 15 are disposed on a base 3. The molded article manufacturing apparatus 1 is configured to be able to manufacture a molded article, by heating the prepreg (insert member) 100, which is impregnated with a thermoplastic resin material, shaping thereafter the prepreg 100 by the mold device 14 and injecting the resin material in the die 51 by the injection device 15.

The prepreg 100 is formed in a sheet shape. The prepreg 100 is formed to have a rectangular plan-view shape in FIG. 1, but the prepreg 100 may be formed in a shape which is suitable for the shaping into the shape of a molded article. The prepreg 100 is formed, for example, in a rectangular shape, a triangular shape, an elliptic shape, or a different shape in which the molded article can be formed.

The storage section 11 is configured to be able to store a plurality of prepregs 100. The storage section 11 is configured to be able to store the prepregs 100, for example, in a vertical attitude. In the meantime, the storage section 11 may be formed, for example, such that the storage section 11 stores prepregs 100 in a horizontal attitude and can change the attitude of the prepregs 100 from the horizontal attitude to the vertical attitude.

In this case, the vertical attitude of the prepreg 100 is an attitude in which a major surface of the prepreg 100 is substantially in the direction of gravity, that is, an attitude in which the major surface of the prepreg 100 extends in an up-and-down direction, or an attitude equal to these attitudes. In addition, the horizontal attitude of the prepreg 100 is an attitude in which a major surface of the prepreg 100 is substantially in the horizontal direction, that is, an attitude in which the major surface of the prepreg 100 extends along the surface of installation of the molded article manufacturing apparatus 1, or an attitude equal to these attitudes.

The convey device 12 is configured such that the prepregs 100 can be successively conveyed in their vertical attitude from the storage section 11 of prepregs 100 to the heating device 13 and the mold device 14. Specifically, the convey device 12 includes a chuck device 21 and a convey mechanism 22.

The chuck device 21 includes, for example, a support portion 31 which is provided on the convey mechanism 22, a plurality of chucks 32, opening/closing means 33 configured to open/close the chucks 32, and a cooling device 34. The chuck device 21 is configured to be able to clamp the prepreg 100 at a plurality of positions by the plural chucks 32.

The support portion 31 is configured to be able to support the plural chucks 32. The support portion 31 is configured to be movable by the convey mechanism 22. The chuck 32 is configured such that the chuck 32 can open/close its distal end portion by being driven by the opening/closing means 33. The chuck 32 is composed of, for example, two mutually opposed claw portions 32a, which move toward or away from each other so that at least distal ends thereof are opened/closed.

The chuck 32 is configured to be able to hold the prepreg 100 by being driven into the closed state by the opening/closing means 33 in the state in which an end portion of the prepreg 100 is positioned between the distal ends of the claw portions 32a, and by this closed state being maintained. The chuck 32 is formed in such a shape that the chuck 32 does not interfere with the die 51 when the chuck 32 conveys the prepreg 100 to the die 51 and inserts the prepreg 100 into the die 51.

The opening/closing means 33 is a driving source for opening/closing the chucks 32 and, for example, a pneumatic cylinder or the like is used as the opening/closing means 33. The opening/closing means 33 is electrically connected to the control device 19 via a signal line S.

The cooling device 34 is configured to be able to cool the chucks 32. The cooling device 34 is configured to be able to cool the chucks 32, for example, by jetting air to the chucks 32. The cooling device 34 is electrically connected to the control device 19 via a signal line S.

The cooling device 34 is configured to be able to cool at least those parts of the claw portions 32a of chucks 32, which come in contact with the prepreg 100, and peripheral areas of such parts. The cooling device 34 is supported by the support portion 31, or is disposed at such a position that the cooling device 34 can cool the chucks 32 in a fabrication process before the chucks 32 move to the storage section 11.

The convey mechanism 22 is a mechanism for successively conveying the chucks 32 of the chuck device 21 to the storage section 11, heating device 13 and mold device 14 and, for example, the convey mechanism 22 is configured to be able to slidably move the support portion 31. The convey mechanism 22 is, for example, a rail or an articulated robot. The convey mechanism 22 is electrically connected to the control device 19 via a signal line S.

As illustrated in FIG. 1, the heating device 13 includes a pair of heating portions 41 which are opposed to each other with a distance therebetween, the pair of heating portions 41 being capable of heating the prepreg 100. The pair of heating portions 41 have heating surfaces 41a for heating the prepreg 100, the heating surfaces 41a being disposed along the major surfaces of the prepreg 100.

Specifically, like the prepreg 100, each of the paired heating portions 41 is disposed in the vertical attitude (e.g., in an attitude of a vertically elongated rectangular parallelepiped disposed substantially along the direction of gravity). The paired heating portions 41 are opposed to each other with such an interval that parts of the distal end portions of the claw portions 32a of the chucks 32 and the prepreg 100, which is held by the chucks 32, can pass through.

For example, the heating portions 41 are formed such that one or plural infrared heaters are provided on the mutually opposed heating surfaces 41a of the heating portions 41, thus being able to heat the prepreg 100, which passes between the heating portions 41, up to a predetermined temperature. Incidentally, the predetermined temperature, in this context, means such a temperature that the prepreg 100 can be shaped in the mold device 14.

The mold device 14 includes an openable/closable die 51, and a mold clamping device 52 which opens/closes the die 51. The mold clamping device 52, or the mold clamping device 52 and injection device 15, are a molding apparatus for forming a molded article.

The die 51 includes a fixed die 53 and a movable die 54. The fixed die 53 has a cavity 53a which is formed in a shape corresponding to a part of a molded article, and a gate 53b which is continuous with the cavity 53a and is formed on a surface facing the injection device 15, on that surface of the fixed die 53, which is opposed to the movable die 54. The fixed die 53 includes a positioning pin for fixing the prepreg 100 which is disposed. The movable die 54 is configured to be movable relative to the fixed die 53.

The movable die 54 has a cavity 54a which is formed in a shape of a part of the molded article, on that surface of the movable die 54, which is opposed to the fixed die 53.

In the die 51, in its closed state, a space in a shape of the molded article is formed by the cavities 53a and 54a of the fixed die 53 and movable die 54.

The mold clamping device 52 is configured to be able to open/close the die 51, and to be able to perform mold clamping. The mold clamping device 52 includes, for example, a fixed platen 56, a movable platen 57 which is movable relative to the fixed platen 56, a toggle mechanism 58 which moves the movable platen 57, a driving source 59 which drives the toggle mechanism 58, and an extrusion device 80.

The fixed platen 56 is configured to be able to support the fixed die 53. The movable platen 57 is configured to be able to support the movable die 54. By being driven by the driving source 59, the toggle mechanism 58 advances/retreats the movable platen 57, relative to the fixed platen 56. The driving source 59 is configured to be able to drive the toggle mechanism 58. The driving source 59 is electrically connected to the control device 19 via a signal line S.

The extrusion device 80 includes, for example, an extrusion member 81, and an extrusion driving unit 82 for driving the extrusion member 81.

The extrusion member 81 includes, for example, an extruding platen 83, an extrusion shaft 84, an extrusion platen 85, and an extrusion pin 86. The extruding platen 83 is provided on that side of the movable platen 57, which is opposite to the fixed platen 56. The extrusion shaft 84 is supported by the extruding platen 83, penetrates the movable platen 57, and extends into the inside of the movable die 54.

The extrusion platen 85 is attached to a distal end portion of the extrusion shaft 84, and is supported inside the movable die 54. The extrusion pin 86 is formed such that the extrusion pin 86 is supported on the extrusion platen 85, penetrates the movable die 54, and can be exposed between the movable die 54 and the fixed die 53. The extruding platen 83, extrusion shaft 84, extrusion platen 85 and extrusion pin 86 are, as one body, advancible/retreatable to/from the movable platen 57.

In the meantime, the structure of the extrusion member 81 is not limited to the above, and the extrusion member 81 may be composed of, for example, an extruding platen 83 and an extrusion pin 86 which is directly fixed to this extruding platen 83. In addition, the extrusion member 81 may be configured such that the extrusion pin 86 is disposed within the movable die 54, and a part or the entirety of the movable die 54 is pushed by the extrusion platen 85.

The extrusion driving unit 82 is electrically connected to the control device 19 via a signal line S.

The injection device 15 includes, for example, a housing 61, a cylinder 62, a screw 63, a hopper 64, moving means 65, a driving device 66, and a cylinder heating device 67. The injection device 15 is configured to be able to inject a resin material as a molding material into the die 51 of the die device 14, thereby the injection device 15 is a molding device for forming a molded article, together with the mold clamping device 52.

The housing 61 is formed, for example, such that the housing 61 can support the cylinder 62, screw 63 and hopper 64, and can house the driving device 66 therein. The cylinder 62 houses the screw 63 therein. The cylinder 62 includes an injection nozzle 62a at a distal end thereof. The injection nozzle 62a is configured to be connectable to the gate 53b formed in the die 51. The screw 63 is configured to be rotatable within the cylinder 62 and to be advancible/retreatable relative to the cylinder 62.

The hopper 64 stores a resin material as a molding material to be melted, with which injection molding is performed. The hopper 64 is configured to be able to supply the stored resin material into the cylinder 62.

The moving means 65 includes, for example, a plurality of rails 71 which are disposed on the base 3 and extend towards the fixed die 53 and fixed platen 56, and a plurality of guides 72 which are provided under the housing 61 and are slidably movable on the rails 71. The moving means 65 is configured to be able to advance/retreat the housing and the respective structures supported on the housing 61 along the rails 71 relative to the die device 14, by the guides 72 being guided on the rails 71.

The driving device 66 includes, for example, a first driving device 74 configured to rotate the screw 63, a second driving device 75 configured to advance/retreat the screw 63 relative to the cylinder 62, and a third driving device 76 configured to advance/retreat the hosing 61 along the rails 71 relative to the die device 14.

The first driving device 74 is configured to be able to supply a fixed amount of resin material which is supplied from the hopper 64, by rotating the screw 63. The first driving device 74, second driving device 75 and third driving device 76 are electrically connected to the control device 19 via signal lines S.

The cylinder heating device 67 is configured to be able to heat the cylinder 62. The cylinder heating device 67 is attached to the cylinder 62. The cylinder heating device 67 is configured to be able to melt the resin material supplied from the hopper 64, by heating the cylinder 62. The cylinder heating device 67 is electrically connected to the control device 19 via a signal line S.

The boring means 16 is composed of, for example, the injection device 15. Specifically, the boring means 16 is configured to be able to make a bore portion 100a, which is continuous with the gate 53b of the fixed die 53, at that position of the prepreg 100 shaped in the die 51, which is opposed to the gate 53b, by a pressure of the resin material at a time when the resin material is injected by the injection device 15.

The control device 19 is configured to be able to control the convey device 12, die device 14 and injection device 15. Specifically, the control device 19 is configured to be able to control the moving operation of the chucks 32 (support portion 31), by controlling the convey mechanism 22. The control device 19 is configured to be able to control the opening/closing operation of the chucks 32, by controlling the opening/closing means 33. The control device 19 is configured to be able to control the cooling of the chucks 32, by controlling the cooling device 34.

The control device 19 is configured to drive the toggle mechanism 58 by controlling the driving source 59, thereby being able to control the advancing/retreating operation of the movable die 54. The control device 19 is configured to control the first driving device 74, second driving device 75 and third driving device 76, thereby being able to control the rotational operation and advancing/retreating operation of the screw 63 and the advancing/retreating operation of the housing 61 (the advancing/retreating operation of the injection device 15). The control device 19 is configured to be able to control the heating operation of the cylinder 62 by controlling the cylinder heating device 67.

In addition, the control device 19 is configured to control the extrusion driving unit 82, thereby driving the extrusion member 81 and being able to control the operation of the extrusion pin 86, and thus the extrusion pin 86 can be exposed from the movable die 54 (the extrusion pin 86 can be exposed between the movable die 54 and the fixed die 53).

Next, a description is given of a method of manufacturing a molded article by using the molded article manufacturing apparatus 1 having the above-described structure.

To start with, the chucks 32 are moved to the storage section 11, and the chucks 32 are set in the open state. In the meantime, when the prepreg 100 was conveyed to the heating device 13 before this cycle, the chucks 32 are cooled by the cooling device 34.

Next, the chucks 32 are further moved, and distal ends of the claw portions 32a are positioned at the peripheral edge (edge portion, end portion) of the prepreg 100. Then, the chucks 32 are set in the closed state, and the prepreg 100 is held by the chucks 32. Next, the chucks 32 are moved, the prepreg 100 is moved into between the paired heating portions 41, and the prepreg 100 is heated up to a predetermined temperature and set in a softened state.

Subsequently, the chucks 32 are moved, the prepreg 100 is conveyed to the die 51, and the prepreg 100 is disposed between the fixed die 53 and movable die 54 of the die 51 (inside the die 51, within the die 51). At this time, the prepreg 100 is disposed such that the prepreg 100 is located at a predetermined position.

Next, the toggle mechanism 58 is driven, and the movable die 54 is moved toward the fixed die 53. At this time, the prepreg 100 is fixed to a positioning pin provided on the fixed die 53. Then, the chucks 32 are set in the open state, the holding of the prepreg 100 is released, and the chucks 32 are separated from the die 51.

Next, the toggle mechanism 58 is further driven, the movable die 54 is moved toward the fixed die 53, and the die 51 is set in the closed state. Thereby, the prepreg 100 is pressed by the die 51, and is shaped in accordance with the shapes of the cavities 53a and 54a.

In conjunction with this, the third driving device 76 is driven to move the housing 61, the injection nozzle 62a is connected to the gate 53b that is formed in the fixed die 53, and the resin material, which is supplied in the cylinder 62 from the hopper 64 and is melted, is injected into the die 51 via the gate 53b.

At this time, the bore portion 100a is formed in the prepreg 100 by a pressure of the resin material at a time when the resin material is injected by the injection device 15 that is the boring means 16, or in other words, by a pressure which is applied to the prepreg 100 by the resin material. Thereby, as illustrated in FIG. 2, the resin material is injected in the cavity 53a, 54a, and the resin material is supplied in the shape of the cavity 53a, 54a and is molded as one body with the shaped prepreg 100. In addition, the bore portion 100a of the prepreg 100, which has been formed at the time of injection, is closed by the resin material when the injected resin material is solidified.

Next, the molded prepreg 100 and the resin material are cooled, and a molded article is formed. Then, the movable die 54 is moved, the die 51 is set in the open state, the molded article is pushed by the extrusion pin 86 that is provided on the movable die 54, and the molded article is taken out of the die 51.

Subsequently, the chucks 32 are cooled by the cooling device 34, the prepreg 100 is conveyed to the heating device 13 once again, and the same fabrication steps are repeated. By the repetition of these fabrication steps, molded articles are manufactured.

According to the molded article manufacturing device 1 with the above-described structure, the bore portion 100a, which is continuous with the gate 53b, is formed in the prepreg 100 by the boring means 16. Thereby, when the prepreg 100 is disposed in the die 51, both surfaces of the prepreg 100 are continuous with the gate 53b. Specifically, since the prepreg 100, which has been heated by the heating device 13 and inserted into the die 51, is in the softened state, the bore portion 100a can be formed in the prepreg 100 by the pressure of the resin material at the time when the resin material is injected by the injection device 15. In other words, the injection device 15 is configured to be able to inject the resin material with such an injection pressure as to be able to bore the prepreg 100. By injecting the resin material in the die 51 with this injection pressure, the prepreg 100 is bored by the injected resin material.

Thereby, there is no need to make a bore (bore portion 100a) in the prepreg 100 in advance, prior to inserting the prepreg 100 in the die device 14. Therefore, according to the molded article manufacturing device 1, it is possible to suppress an increase in the manufacturing cycle of the molded article and an increase in the manufacturing cost, due to forming the bore portion 100a in the prepreg 100 in advance.

In addition, parts molded by injection molding can be formed on both surfaces of the prepreg 100 in accordance with the shapes of the cavities 53a and 54a in the die 51, and the shape and the degree of freedom of the molded article can be improved.

Further, the die 51 is configured to be able to supply the resin material to both surfaces of the prepreg 100 by the bore portion 100a of the prepreg 100. Thereby, the die 51 can be made to have a simple structure, without making the shape of the gate 53b complex, and without the need to extend the gate 53b up to not only the fixed die 53 but also the movable die 54. Furthermore, as regards the die 51, the length of the gate 53b can be reduced to a minimum, the amount of resin material which is used for injection molding can be decreased, and the manufacturing cost can be reduced.

Moreover, since injection molding can be performed on both surfaces of the prepreg 100, the extrusion pin 86 for taking out the formed molded article from the die 51 can be provided on the movable die 54. Specifically, since injection molding can be performed on the movable die 54 side of the prepreg 100, such a configuration is possible that the molded article after molding is disposed on the movable die 54 when the die 51 is set in the open state, and the extrusion pin 86 can be disposed on the movable die 54. Thereby, it is possible to avoid such a structure that a stripper plate is provided on the fixed die 53, and it is thus possible to reduce the equipment cost and to prevent a high load from being applied to the driving source 59 by the provision of the stripper plate.

As has been described above, according to the molded article manufacturing apparatus 1 relating to the embodiment of the invention, injection molding can easily be performed on the prepreg 100 by such a simple structure that the bore portion 100a, which is continuous with the gate 53b, is formed in the prepreg 100 by the boring means 16.

### Second Embodiment

Next, a molded article manufacturing apparatus 1 according to a second embodiment of the invention will be described hereinafter. Incidentally, except for the structure of the boring means 16, the molded article manufacturing apparatus 1 according to the second embodiment is the same as the molded article manufacturing apparatus 1 according to the first embodiment, and thus a description of the parts other than the structure of the boring means 16 is omitted.

The boring means 16, which is used in the molded article manufacturing apparatus 1, is an extrusion pin 86 which is provided on the extrusion member 81 of the extrusion device 80 or the movable die 54. For example, the extrusion pin 86 has a distal end formed in a conical shape. In addition, the extrusion pin 86 is disposed at a position facing the gate 53b. The boring means 16 is configured to be able to make a bore in the prepreg 100 at a position facing the gate 53b, the prepreg 100 being heated by the heating device 13 and inserted into the die 51.

In the molded article manufacturing apparatus 1 with this structure, the prepreg 100, which has been heated by the heating device 13 and inserted into the die 51, is in the softened state. Thus, the bore portion 100a can be formed in the prepreg 100 by driving the extrusion member 81 in the state in which the prepreg 100 is inserted into the die 51, projecting the extrusion pin 86 from the movable die 54, and pulling back, before injection, the extrusion pin 86 into the movable die 54, that is, in the die 51, by driving the extrusion member 81. In addition, even if the bore portion 100a, which has been formed by the extrusion pin 86, is small, the bore portion 100a can be broadened by the pressure of the injected resin material. Thus, the injected resin material can easily be caused to flow to the cavity 54a of the movable die 54. Thereby, the injected resin material can be supplied to both surfaces of the prepreg 100 in the die 51.

Further, in the molded article manufacturing apparatus 1, like the molded article manufacturing apparatus 1 of the first embodiment, it is not necessary to make the bore portion 100a in the prepreg 100 in advance, prior to inserting the prepreg 100 in the die device 14. Thus, according to the molded article manufacturing apparatus 1, it is possible to suppress an increase in the manufacturing cycle of the molded article and an increase in the manufacturing cost, due to forming the bore portion 100a in the prepreg 100 in advance.

As has been described above, according to the molded article manufacturing apparatus 1 relating to the second embodiment, like the molded article manufacturing apparatus 1 relating to the first embodiment, injection molding can easily be performed on the prepreg 100 by such a simple structure that the bore portion 100a, which is continuous with the gate 53b, is formed in the prepreg 100 by the boring means 16.

In the meantime, the present invention is not limited to the above-described embodiments. For instance, in the above-described example, the description has been given of the structure in which the die 51 is composed of the fixed die 53 having the gate 53b and the movable die 54. However, the invention is not limited to this example. For example, the die 51 may be configured such that the fixed die 53 includes a valve gate which is opened/closed by a pin.

In addition, in the above-described example, the description has been given of the structure of the molded article manufacturing apparatus 1, in which the boring means 16 for forming the bore portion 100a, which is continuous with the gate 53b, in the prepreg 100 is the injection device 15 or the extrusion pin 86. However, the invention is not limited to this example.

For example, the boring means 16 may be configured to bore the prepreg 100 by a positioning pin provided on the fixed die 53. In addition, the boring means 16 may be configured such that a valve gate, which is opened/closed by a pin, is provided on the fixed die 53, and the prepreg 100 is bored by the pin of this valve gate. In this case, in addition to the above-described advantageous effects, such an advantage can be obtained that the die structure can be simplified, and it is possible to adapt to a multipoint gate.

Furthermore, the boring means 16 may be, for example, a trimming device which can make the bore portion 100a in the prepreg 100. Such boring means 16 can form the bore portion 100a in a prepreg 100 before it is stored in the storage section 100, before it is moved from the storage section 100 to the heating device 13, or before it is moved from the heating device 13 to the die device 14.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A molded article manufacturing apparatus comprising:
a mold clamping device configured to be able to support a die which shapes a sheet-shaped insert member, the die including a fixed die with a gate, and a movable die which is movable relative to the fixed die;
an injection device configured to inject a molding material into the die; and
boring means configured to form a bore portion, which is continuous with the gate, in the insert member which is inserted into the die that is supported by the mold clamping device.

2. The molded article manufacturing apparatus of claim 1, wherein the boring means is configured to form the bore portion in the insert member, which is inserted into the die, by a pressure of the molding material at a time when the molding material is injected by the injection device.

3. The molded article manufacturing apparatus of claim 1, wherein the mold clamping device includes an extrusion pin configured to be able to push a molded article after molding, and
the extrusion pin is the boring means configured to form the bore portion in the insert member which is inserted into the die.

4. The molded article manufacturing apparatus of claim 1, further comprising an extrusion pin configured to be able to push a molded article after molding, the extrusion pin being provided on the die which is supported by the mold clamping device,
wherein the extrusion pin is the boring means configured to form the bore portion in the insert member which is inserted into the die.

5. A method of manufacturing a molded article, comprising:
inserting a sheet-shaped insert member in a die including a fixed die with a gate, and a movable die which is movable relative to the fixed die;
shaping, by the die, the insert member which is inserted;
injecting, by an injection device, a molding material into the die; and
boring the insert member by a pressure of the molding material which is injected by the injection device.

6. A method of manufacturing a molded article, comprising:
inserting a sheet-shaped insert member into a die including a fixed die with a gate, and a movable die which is movable relative to the fixed die;
shaping, by the die, the insert member which is inserted;
boring the insert member by an extrusion pin configured to be able to push a molded article after molding; and
injecting, by an injection device, a molding material into the die.
